(19) United States
(12) Patent Application Publication
(10) Pub. No.: US 2007/0086122 A1
(43) Pub. Date: Apr. 19, 2007

(54) CPP magnetoresistive sensor having a reduced, shield defined track width

(75) Inventors: James Mac Freitag, Sunnyvale, CA (US); Kuok San Ho, Santa Clara, CA (US); Mustafa Michael Pinarbasi, Morgan Hill, CA (US); Ching Hwa Tsang, Sunnyvale, CA (US)

Correspondence Address: ZILKA-KOTAB, PC, P.O. BOX 721120, SAN JOSE, CA, 95172-1120, US

(73) Assignee: HITACHI GLOBAL STORAGE TECHNOLOGIES

(21) Appl. No.: 11/254,349

(22) Filed: Oct. 19, 2005

(51) Int. Cl. G11B 5/33; G11B 5/127

(52) U.S. Cl. 360/324.2

(57) ABSTRACT

A current perpendicular to plane (CPP) magnetoresistive sensor having a track width that is defined by an area of contact with a shield/lead. The sensor includes a sensor stack having a width W1. A current path defining insulation layer formed over the sensor stack has an opening with a width W2 that is significantly smaller than the width W1 of the sensor stack. A shield/lead extends into the opening in the insulation layer to contact a surface of the sensor stack. This area of contact between the shield/lead and the surface of the sensor stack defines an active area of the sensor having a width of substantially W2. The edges of the sensor stack, which may have compromised magnetic properties due to the formation of the sensor stack are advantageously removed from the active area of the senor. Furthermore, the edges of the free layer, which may be pinned by the hard bias layers are also advantageously removed from the active area of the sensor.

### FIELD OF THE INVENTION

The present invention relates to magnetoresistive sensors and more particularly to a current perpendicular to plane (CPP) magnetoresistive sensor having a track width defined by a lead contact area.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating but, when the disk rotates, air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic impressions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. The sensor includes a nonmagnetic conductive layer, hereinafter referred to as a spacer layer, sandwiched between first and second ferromagnetic layers, hereinafter referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

When a spin valve sensor employs a single pinned layer it is referred to as a simple spin valve. When a spin valve employs an antiparallel (AP) pinned layer it is referred to as an AP pinned spin valve. An AP spin valve includes first and second magnetic layers separated by a thin non-magnetic coupling layer such as Ru. The thickness of the spacer layer is chosen so as to antiparallel couple the magnetizations of the ferromagnetic layers of the pinned layer. A spin valve is also known as a top or bottom spin valve depending upon whether the pinning layer is at the top (formed after the free layer) or at the bottom (before the free layer).

The spin valve sensor is located between first and second nonmagnetic electrically insulating read gap layers and the first and second read gap layers are located between ferromagnetic first and second shield layers. In a merged magnetic head a single ferromagnetic layer functions as the second shield layer of the read head and as the first pole piece layer of the write head. In a piggyback head the second shield layer and the first pole piece layer are separate layers.

Magnetization of the pinned layer is usually fixed by exchange coupling one of the ferromagnetic layers (AP1) with a layer of antiferromagnetic material such as PtMn. While an antiferromagnetic (AFM) material such as PtMn does not in and of itself have a magnetization, when exchange coupled with a magnetic material, it can strongly pin the magnetization of the ferromagnetic layer.

The ever increasing demand for increased data rate and data capacity has lead a relentless push to develop magnetoresistive sensors having improved signal amplitude and reduced track width. Sensors that show promise in achieving higher signal amplitude are current perpendicular to plane (CPP) sensors. Such sensors conduct sense current from top to bottom, perpendicular to the planes of the sensor layers. Examples of CPP sensors include CPP GMR sensors and tunnel valve sensors. A CPP sensor operates based on the spin dependent scattering of electrons through the sensor, similar to a more traditional CIP GMR sensor except that, as mentioned above, the sense current flows perpendicular to the plane of the layers. A tunnel valve operates based on the spin dependent tunneling of electrons through a non-magnetic, electrically insulating barrier layer.

One way to improve the data capacity of a magnetic recording system is to increase the number of tracks of data that can fit onto a given area of the magnetic medium. To achieve this, sensors must be constructed with ever decreasing track widths. The track width of a sensor is generally defined by a photolithographic process that defines the width of the sensor itself. The sensor layers are applied as full film layers. A mask is constructed and a milling operation is performed to remove material not covered by the mask. The milling processes used to define the trackwidth of the sensor results in a certain amount of damage to the sensor layers at the sides of the sensor. In a sensor having a relatively wide track width, this damaged portion is a small proportion of the overall sensor and is therefore, acceptable. However, as sensors become ever smaller, having narrower trackwidths, the damaged portion at the sides of the sensor makes up a large proportion of the total sensor and the performance of the sensor suffers.

Another factor affecting sensor performance is free layer biasing. Current magnetoresistive sensors, whether CPP or CIP, are biased by providing hard magnetic bias layers at either side of the sensor. A magnetic field from each of the bias layers magnetostatically couples with the sides of the free layer. However, the biasing is not uniform throughout the free layer. In order to have sufficient biasing at the center of the free layer, the bias field must be so strong that the lateral sides of the free layer are effectively pinned, while the center portion maintains sufficient sensitivity to detect a magnetic signal. However, as sensor trackwidths decrease, the pinned portion of the free layer makes up a large proportion of the free layer. The free layer looses sensitivity, being unable to detect magnetic fields.

Therefore, there is a strong felt need for a sensor design that can provide a narrow track width, while minimizing the effect of damage to the sides of the sensor and maintaining free layer sensitivity. Such a design would preferably be embodied in a CPP sensor such as CPP GMR sensor or a tunnel valve, since these are the sensor designs of most interest for future magnetic recording systems.

### SUMMARY OF THE INVENTION

The present invention provides a current perpendicular to plane (CPP) magnetoresistive sensor having a sensor stack that extends laterally beyond its active area, the active area being controlled by a current path that is narrower than the sensor stack itself.

The sensor stack has first and second laterally opposed sides that define a first width W1. A current path defining insulation layer, formed over a surface of the sensor stack has an opening with a width W2, the width W2 being substantially smaller than the width W1. An electrically conductive shield extends into the opening in the insulation layer. Therefore, the width of the opening largely controls the active area of the sensor and, therefore, is a key parameter in defining track width of the sensor.

Since the sensor is a CPP sensor it may have first and second leads formed at the top and bottom of the sensor stack that are constructed of an electrically conductive, magnetic material which function as magnetic shields as well as electrical leads. The sensor can be a CPP GMR sensor or can be a tunnel valve sensor.

The width W1 of the sensor stack can be at least 2 times W2 or about 3 times the W2. First and second hard bias layers can be provided at either side of the sensor to provide a bias field to bias the magnetic moment of the free layer.

Because the magnetostatic coupling of the bias layers with the free layer occurs far outside of the active area of the sensor (ie. at the outer edges of the sensor stack) the strongly biased portions of the free layer remain outside of the active area of the sensor, so that in the active area of the sensor, the free layer maintains excellent sensitivity even at very small effective track widths.

In addition, should any damage occur to the sides of the sensor layers during the track width defining ion mill process, these damaged portions of the sensor layers are well outside of the active area of the sensor. The sensor therefore, maintains excellent magnetic properties at very small effective track widths.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon; and

FIG. 3 is an enlarged ABS view taken from circle 3 of FIG. 2 rotated 90 degrees counterclockwise.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

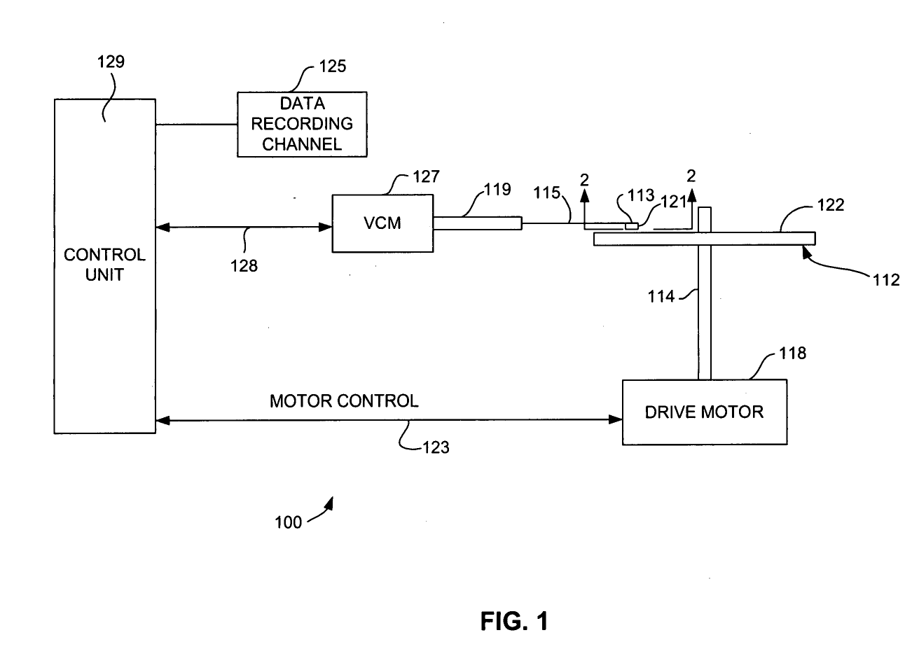

Referring now to FIG. 1, there is shown a disk drive 100 embodying this invention. As shown in FIG.1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

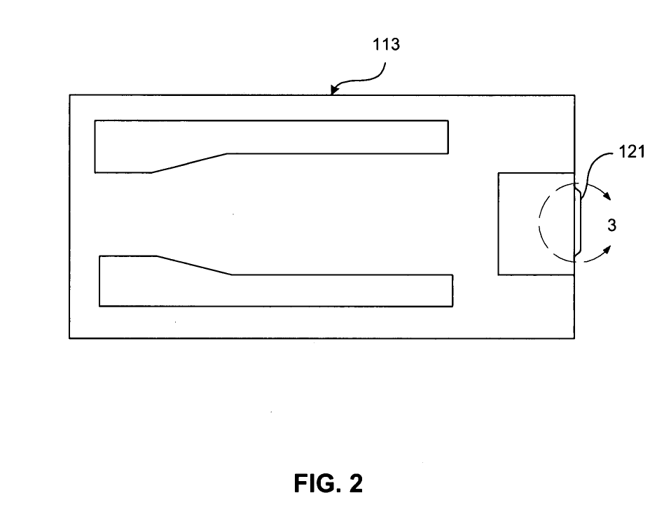

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

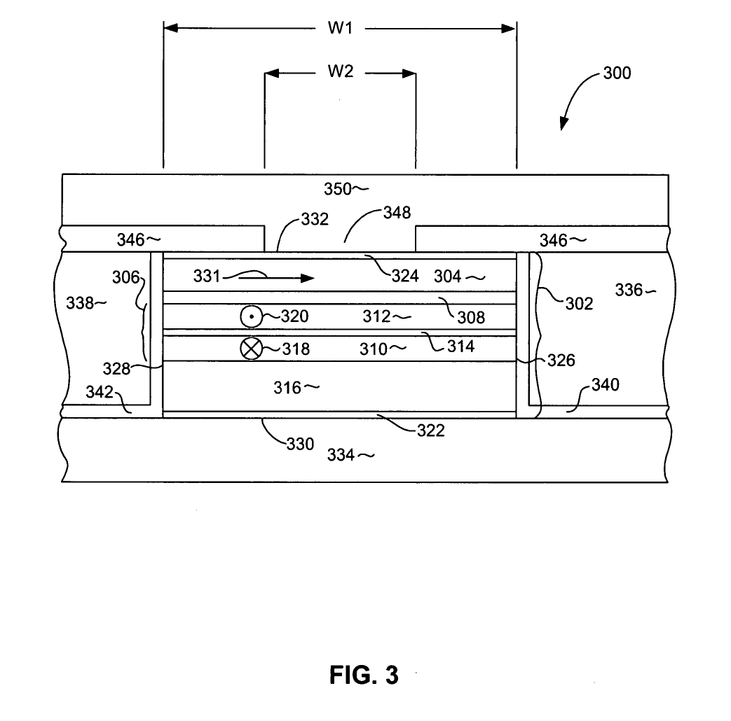

With reference now to FIG. 3, a CPP magnetorsistive sensor according to an embodiment of the invention is described, the sensor being shown as viewed from the air bearing surface (ABS). The invention will be described in terms of a tunnel valve, but it should be understood that the invention would also apply to a CPP GMR sensor as well. The invention includes a sensor stack 302 that includes a free layer 304, a pinned layer structure 306 and a non-magnetic electrically insulating barrier layer 308 sandwiched between the free layer 304 and pinned layer structure 306. The free layer 304 can be constructed of, for example, Co, CoFe, NiFe or a combination of layers of these materials. The barrier layer 308 can be for example alumina (Al₂O₃). The sensor 300 can also be a GMR sensor. If the sensor 300 were embodied in a CPP GMR sensor, the layer 308 would be an electrically conductive spacer such as Cu.

The pinned layer structure 306 may be one of several pinned layer designs, but preferably includes a first magnetic layer AP2 310 a second magnetic layer AP2 312 and a non-magnetic, electrically conductive AP coupling layer 314 sandwiched between the AP1 and AP2 layers 310, 312. The AP1 and AP2 layers 310, 312 can be constructed of several magnetic materials and are preferably constructed of CoFe. The AP coupling layer 314 can be constructed of, for example Ru.

The AP1 layer 310 is exchange coupled with a layer of antiferromagnetic material (AFM layer) 316 such as IrMn or PtMn. The exchange coupling pins the magnetic moment 318 of the AP1 layer in a desired direction perpendicular to the ABS as shown. antiparellel coupling between the AP1 and AP2 layers pins the magnetic moment of the AP2 layer 320 in a direction antiparallel with the moment 318 of the AP1 layer 310.

A seed layer 322 may be provided at the bottom of the sensor stack 302 to promote a desired crystalline growth in the sensor layers deposited there on. In addition, a capping layer 324, such as Ta may be provided at the top of the sensor stack to prevent damage to the sensor layers during manufacture.

With continued reference to FIG. 3, the sensor stack has a width (W1) defined by first and second side walls 326, 328 of the sensor stack 302. The sensor also has first and second surfaces 330, 332 which each extend from the first side 326 to the second side 328 and from the ABS to a stripe height (not shown), and which extend along a plane that is oriented generally perpendicular to the ABS. Those skilled in the art will recognize that the stripe height is the edge of the sensor stack at a point into the plane of the page in FIG. 3.

A first shield/lead 334 contacts the first surface 330 of the sensor stack 302. The shield 334 is constructed of a magnetic, electrically conductive material so that it functions as an electrical lead as well as a magnetic shield. Therefore, the shield/lead 334 will be referred to herein as a lead 334. First and second hard bias layers 336, 338 are formed at either side of the sensor stack 302. The hard bias layers 336, 338 are constructed of a hard magnetic material such as CoPt or CoPtCr and provide a magnetic bias field that biases the magnetic moment 331 of the free layer 304 in a desired direction parallel with the ABS. The bias layers 336, 338 may be separated from the sensor stack and from the first shield by insulation layers 340, 342, in order to prevent shunting of sense current through the bias layers 336, 338.

With continued reference to FIG. 3, a current path defining insulation layer 346 is formed over the second surface of the sensor stack, preferably extending over the bias layers 336, 338 as well. The current path defining insulation layer has an opening 348 with a width W2. A second lead 350 extends through the opening 348 to contact the second surface 332 of the sensor stack 302. As with the first lead 334, the second lead 350 can be constructed of an electrically conductive, magnetic material such as NiFe to function as a magnetic shield as well as an electrical lead, or could be non-magnetic. The insulation layer 346 can be constructed of, for example alumina (Al₂O₃).

A method for forming the insulation layer 346 includes first forming a mask having a width W2 over the sensor stack 302, and then depositing an electrically insulating material. The mask can then be lifted off, such as by chemical mechanical polishing or chemical lift off, leaving the opening 348 in the insulation layer 346.

After the insulation layer 346 has been formed, the leads/shields 350 can be deposited, such as by sputter deposition, electroplating, or more preferably a combination of these two deposition methods. As can be seen, the area of contact between the sensor stack 302 and the second lead 350 defines the active area of the sensor. The effective track width of the sensor may be larger than the physical width W2, because a certain amount of current may spread outward as it travels through the sensor. Nevertheless, the trackwidth is well inside of the width W1 of the sensor stack 302, and therefore the possibly damaged edges are substantially removed from the active area of the sensor.

Likewise, the strongly biased (possibly pinned) portions at the outer edges of the free layer are also removed from the active area. As can be seen, the bias layers 336, 338 magnetostatically couple with the free layer in a region that is well outside of the active area of the sensor. This magnetostatic coupling can be very strong, even strong enough to essentially pin the free layer 304 at the outermost portions of the free layer, and yet the biasing in the active portion can be uniform and of much lower strength. In order to provide a desired uniform free layer biasing, the width W1 of the sensor stack is greater than the width W2 of the opening in the insulation layer 346. The width W1 is preferably at least 2 times the width W2 or about 3 times W2.

While various embodiments have been described above, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A current perpendicular to plane (CPP) magnetoresistive sensor, comprising:
a sensor stack having first and second laterally opposed sides separated from one another by first width W1 and first and second surfaces, each surface extending from the first side to the second side;
a first electrical lead contacting the first surface of the sensor stack;
a current path defining insulation layer contacting the second surface, the current path defining insulation layer comprising an electrically insulating material and having an opening with a width W2 that is smaller than the width W1 of the sensor stack; and
a second electrical lead extending through the opening in the conduction path defining insulation layer and contacting the second surface of the sensor stack through the opening in the current path defining insulation layer.

2. A CPP magnetoresistive sensor as in claim 1 wherein W1 is about at least 2 times times W2.

3. A CPP magnetoresistive sensor as in claim 1 further comprising first and second hard bias layers extending laterally from the first and second sides of the sensor stack, the first and second hard bias layers being separated from the sensor stack by first and second insulation layers.

4. A CPP magnetoresistive sensor as in claim 1 wherein the sensor stack comprises:
a free layer;
a pinned layer; and
a thin, non-magnetic, electrically insulating barrier layer sandwiched between the free layer and the pinned layer.

5. A CPP magnetoresistive sensor as in claim 1 wherein the sensor stack further
comprises;
a free layer;
a pinned layer; and
a non-magnetic, electrically conductive spacer layer sandwiched between the pinned layer and the free layer.

6. A CPP magnetoresistive sensor as in claim 1 wherein the first and second leads are constructed of an electrically conductive, magnetic material so that they function both as magnetic shields and electrical leads.

7. A CPP magnetoresistive sensor as in claim 1 wherein the first and second leads comprise a non-magnetic, electrically conductive material.

8. A CPP magnetoresistive sensor as in claim 1 wherein W1 is about 3 times W2.

9. A CPP magnetoresistive sensor as in claim 1 wherein the sensor stack comprises:
a seed layer;
an AFM layer deposited over the seed layer;
a pinned layer structure formed over the AFM layer;
an electrically insulating, non-magnetic barrier layer formed over the pinned layer structure;
a free layer formed over the barrier layer; and
a capping layer formed over the free layer, and wherein the seed layer is in electrical contact with the first lead and the capping layer is in electrical contact with the second lead.

10. A CPP magnetoresistive sensor as in claim 1 wherein the opening in the current path defining insulation layer is a key parameter that defines an active area of the sensor.

11. A CPP magnetoresistive sensor as in claim 1 wherein the current path defining insulation layer comprises alumina.

12. A CPP magnetoresistive sensor as in claim 1 wherein the opening in the current path defining insulation layer is substantially, laterally centrally disposed over the sensor stack.

13. A CPP magnetoresistive sensor as in claim 1 wherein the sensor stack comprises:
a seed layer;
an AFM layer deposited over the seed layer;
a pinned layer structure formed over the AFM layer;
an electrically conductive, non-magnetic spacer layer formed over the pinned layer structure;
a free layer formed over the barrier layer; and
a capping layer formed over the free layer, and wherein the seed layer is in electrical contact with the first lead and the capping layer is in electrical contact with the second lead.

14. A suspension arm assembly, comprising:
a suspension arm;
a slider connected with an end of the suspension arm; and
a current perpendicular to plane (CPP) magnetoresistive sensor connected with the slider, the sensor comprising:
a sensor stack having first and second laterally opposed sides separated from one another by first width W1 and first and second surfaces, each surface extending from the first side to the second side;
a first electrical lead contacting the first surface of the sensor stack;
a track width defining insulation layer contacting the second surface, the track width defining insulation comprising an electrically insulating material and having an opening with a width W2 that is smaller than the width W1 of the sensor stack; and
a second electrical lead extending through the opening in the track width defining insulation layer and contacting the second surface of the sensor stack through the opening in the track width defining insulation layer.

15. A magnetic data recording system, comprising:
a magnetic medium;
an actuator;
a slider connected with the actuator for movement adjacent to a surface of the magnetic medium; and
a current perpendicular to plane (CPP) magnetoresistive sensor connected with the slider, the sensor comprising:
a sensor stack having first and second laterally opposed sides separated from one another by first width W1 and first and second surfaces, each surface extending from the first side to the second side;
a first electrical lead contacting the first surface of the sensor stack;
a track width defining insulation layer contacting the second surface, the trackwidth defining insulation comprising an electrically insulating material and having an opening with a width W2 that is smaller than the width W1 of the sensor stack; and
a second electrical lead extending through the opening in the track width defining insulation layer and contacting the second surface of the sensor stack through the opening in the track width defining insulation layer.

16. A method for constructing a current perpendicular to plane (CPP) magnetoresistive sensor, comprising:
constructing a sensor stack having first and second laterally opposed sides separated by a first width (W1) and having a surface extending from the first side to the second side; and
forming a mask over a portion of the surface of the sensor stack, the mask having a second width (W2) that is smaller than W1;
depositing a layer of electrically insulating material (insulation layer) over the mask and sensor stack;
lifting off the mask, leaving an opening in the insulation layer, the opening having a width substantially equal to W2; and
depositing an electrically conductive lead material over the insulation layer, the electrically conductive lead material extending into the opening in the insulation layer to contact the surface of the sensor stack.

17. A method as in claim 16 wherein W1 is about at least 2 times W2.

18. A method as in claim 16 wherein W1 is about 3 times W2.

19. A current perpendicular to plane (CPP) magnetoresistive sensor, comprising:
a sensor stack having first and second laterally opposed sides and a surface extending from the first side to the second side, the first and second sides being separated by a width W1;
an electrically conductive lead contacting the surface of the sensor stack, the area of contact between the electrically conductive lead and the sensor stack defining an electrical contact area having a width W2, W2 being smaller than W1.

20. A sensor as in claim 19, wherein the W1 is at least 2 times W2.

21. A sensor stack as in claim 19 wherein W1 is about 3 times W2.

22. A sensor stack as in claim 19 wherein W2 is defined by first and second current defining insulation layers formed on the surface of the sensor stack between the electrical contact area and each side of the sensor stack.
